(19) United States
(12) Patent Application Publication
(10) Pub. No.: US 2016/0004535 A1
(43) Pub. Date: Jan. 7, 2016

(54) METHOD OF OPERATING A MULTI-THREAD CAPABLE PROCESSOR SYSTEM, AN AUTOMOTIVE SYSTEM COMPRISING SUCH MULTI-THREAD CAPABLE PROCESSOR SYSTEM, AND A COMPUTER PROGRAM PRODUCT

(71) Applicants: Alistair ROBERTSON, (US); Jeffrey W. SCOTT, (US)

(72) Inventors: Alistair ROBERTSON, Glasgow (GB); Jeffrey W. SCOTT, Austin, TX (US)

(21) Appl. No.: 14/767,297

(22) PCT Filed: Feb. 15, 2013
(86) PCT No.: PCT/IB2013/051258

§ 371 Date: Aug. 12, 2015

(51) Int. Cl. G06F 9/30; G06F 9/38

(52) U.S. Cl. CPC G06F 9/30189; G06F 9/30185; G06F 9/3851

(57) ABSTRACT

A method of operating a multi-thread capable processor system comprising a plurality of processor pipelines is described. The method comprises fetching an instruction comprising an address and selecting an operation mode based on the address of the fetched instruction, the operation mode being selected from at least a lock-step mode and a multi-thread mode. If the operation mode is selected to be the lock-step mode, the method comprises letting at least two processor pipelines of the multi-thread capable processor system execute the instruction in lock-step mode to obtain respective lock-step results, comparing the respective lock-step results against a comparison criterion for determining whether the respective lock-step results match, and, if the respective lock-step results match, determine a matching result from the respective lock-step results, and writing back the matching results.

### FIELD OF THE INVENTION

This invention relates to a method of operating a processor system, a processor system, an automotive system comprising such processor system, and a computer program product.

### BACKGROUND OF THE INVENTION

Embedded and autonomous microprocessor cores are used in a wide variety of devices, systems and applications. Dedicated, low-cost single-thread Central Processing Unit (CPU), single-core microcontrollers (MCUs) are used for low-cost applications, low-cost subsystems, and to implement specific, dedicated functions. Advanced, multi-thread CPUs in single- or multiple-core MCUs are used for high-performance applications and high-performance sub-systems, such as high-data throughput processes and parallel processing. Further, specific cores are available for high-safety applications, such as, for example, automotive motor control and automotive lighting control. Such specific cores may, for example, be provided with a so-called lock-step mode of operation, wherein, e.g., the same process is executed on the same data in a synchronized manner in parallel threads on different processing pipelines. In lock-step operation, a first context is provided with a first thread, a second context is provided with a second thread, the second context being used as a secondary image of the first context, and comparisons—usually by a dedicated hardware unit-are made to ensure identical operation and identical results between the threads. The first and second context may be provided on a multi-threaded processor with lock-step capability. The multi-threaded processor with lock-step capability may be provided by a single CPU with a plurality of processor pipelines, or by a plurality of CPUs that are operated in lock-step mode.

For various reasons, such as to provide further flexibility between high performance and high safety operation, microprocessor cores are being developed which may be operated in different modes. For example, a microprocessor core may be configured to operate in single threaded lock-step mode if used in a safety-critical application, or in a multi-threaded non-lock-step mode if used in a high-performance application. Available contexts and execution units may then be used to operate on and store the relevant data of a single safety-critical process in parallel, with a hardware comparison to check for consistency between the two—or more-threads, when used in lock-step mode, whereas the available contexts and execution units may then be used to operate in parallel on and store the relevant data of each different thread when used in multi-thread mode.

High safety-level applications are e.g. required in automotive applications, where safety levels have been standardized using, e.g., Functional Safety standard ISO 26262 “Road vehicles—Functional safety”. The standard ISO 26262 is an adaptation of an earlier Functional Safety standard IEC 61508 for Automotive Electric/Electronic Systems. ISO 26262 defines functional safety for automotive equipment applicable throughout the lifecycle of all automotive electronic and electrical safety-related systems. Its first edition, published on 11 Nov. 2011, applies to electrical and/or electronic systems installed in “series production passenger cars” with a maximum gross weight of 3500 kg, and aims to address possible hazards caused by the malfunctioning behaviour of electronic and electrical systems. Like its parent standard IEC 61508, ISO 26262 is risk based safety standard, where the risk of hazardous operational situations are qualitatively assessed and safety measures are defined to avoid or control systematic failures and to detect or control random hardware failures, or mitigate their effects. ISO 26262 provides an automotive-specific risk-based approach for determining risk classes, referred to as Automotive Safety Integrity Levels or ASILs, A, B, C & D, with a decreasing amount of risk of failure associated with each level respectively. ISO 26262 uses ASILs for specifying an item's necessary safety requirements for achieving an acceptable residual risk. As a risk based safety standard, the risk of various types of failure is assessed and safety measures are developed and put in place to mitigate such failures or at least mitigate their effects. In the following, the term ASIL-x refers to either ASIL-A, ASIL-B, ASIL-C or ASIL-D functional safety levels. Examples of the ASIL-D level (the highest functional safety level) functions in an automotive system may be a control of the breaks in response to a driver operating the breaking pedal, an automatic braking system (ABS) function or an electronic stability program (ESP) function, an exemplary ASIL-C level function may be correct operation of a tire pressure sensor monitoring system, exemplary ASIL-B level function may be correct operation of a parking sensor control system, and an exemplary ASIL-A level function may be a download of updates for a vehicle's navigation system.

Currently available (multithread) microprocessor cores capable to be operated in different modes need to be configured on one of the modes in a one-time programming stage prior to their use, or at startup. There may be a wish to be able to provide multi-thread microprocessor cores that are capable of, and methods of operating multi-thread microprocessor cores, operating in different modes during run-time and switching between different modes of operation. For example, there may be a wish to operate a multi-thread core, for example a two-thread capable core, dynamically between a Single Thread (ST) mode, where a portion of the CPU (additional context & execution units for the second thread) remains unused, a high-performance multithread (MT) mode where both available contexts and execution units are used to store the relevant data for each thread, and a high-safety level Lock-step (LS) mode, where the additional context is used as a secondary image of the first, with hardware comparisons made to ensure identical operation between threads. Further, there may be a wish to provide such multi-thread core with smooth transitioning between these modes for different portions of the application.

### SUMMARY OF THE INVENTION

The present invention provides a method of operating a processor system, a processor system, an automotive system comprising such processor system, and a computer program product as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals.

FIG. 1 schematically shows an example of an embodiment of an automotive electronic control unit comprising a microcontroller;

FIG. 2 schematically shows further details of an embodiment of an electronic control unit comprising a microcontroller;

FIG. 3 schematically shows a method of operation comprising operation in different modes and transitions between the modes;

FIG. 4a and FIG. 4b schematically illustrate a prior art and an embodiment of a MAS register usable for controlling loading data from the memory into a cache; FIG. 4c schematically illustrates an attribute table according to an embodiment;

FIG. 5 schematically shows a method of operating a multi-thread capable processor system comprising a plurality of processor pipelines;

FIG. 6a, FIG. 6b and FIG. 6c schematically shows operating the multi-thread capable processor system in different modes;

FIG. 7 schematically shows an exemplary user interaction system; and

FIG. 8 shows a computer readable medium comprising a computer program product.

### DETAILED DESCRIPTION OF THE PREFERRED EMBODIMENTS

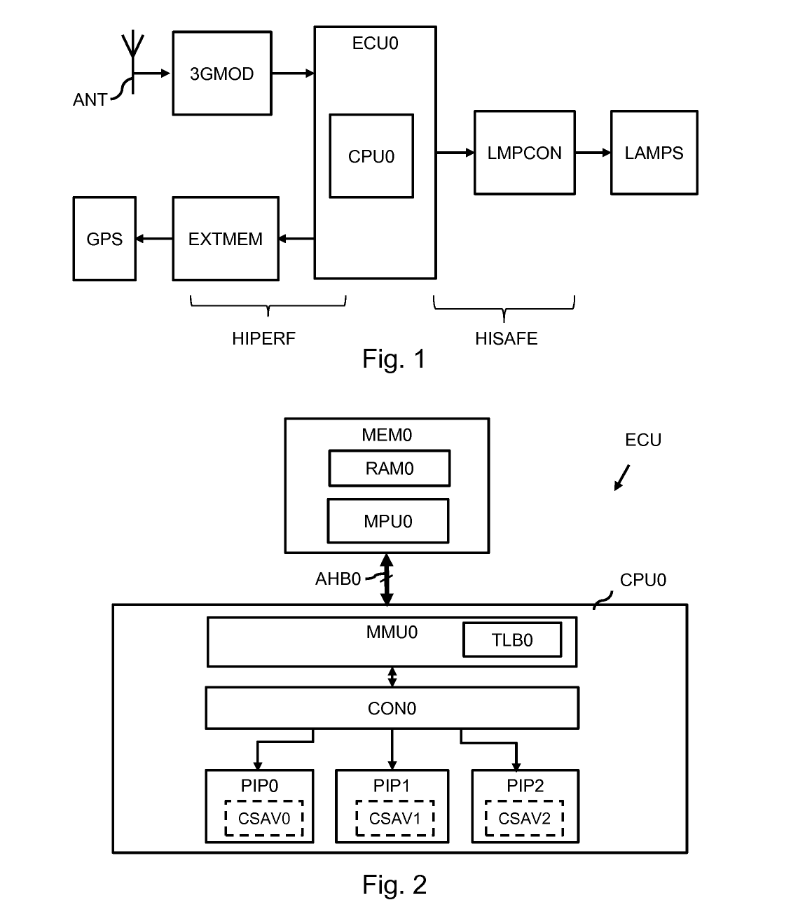

FIG. 1 schematically shows a microcontroller CPU0, here represented by an exemplary integrated gateway/body controller microcontroller for a vehicle. The microcontroller CPU0 is shown to reside within an ECU (electronic control unit) ECUO in a vehicle, such as a car. The microcontroller CPU0 is arranged to control all communications around the vehicle. Some of the control may require a high performance (schematically indicated as HIPERF) but are not related to safety critical systems such as a download of a memory update data via a USB-controlled 3G modem 3GMOD from a wireless transmission received by an antenna ANT, and a routing of the downloaded memory update to an external memory EXTMEM via an SDHC interface, for example for use by a vehicle's navigation and global positioning system GPS. Some other control may be associated with a high safety level requirement (schematically indicated as HISAFE). The microcontroller CPU0 may, e.g., be further arranged to control the vehicle lighting system LMPCON which is a relatively low performance but high safety level application, as a reliable operation of the lamps LMPS, such as of break lamps, is usually required. Hereto, the microcontroller CPU0 comprises two processor pipelines. The processor pipelines are arranged to operate in a lock step mode for controlling a safety critical device, such as the safety critical vehicle lighting system, whereas processor pipelines are arranged to operate in a high-performance multithread mode for operating a high-performance device, such as the download and routing of the memory update data.

The system shown in FIG. 1 thus provides an example of an automotive system comprising a multi-thread capable processor system and a safety-critical device, wherein the multi-thread capable processor system unit is arranged to operate in lock-step mode in operating the safety-critical device. In further embodiments, the automotive system comprises a high-performance device, the multi-thread capable processor system unit being arranged to operate in multithread mode in operating the high-performance device.

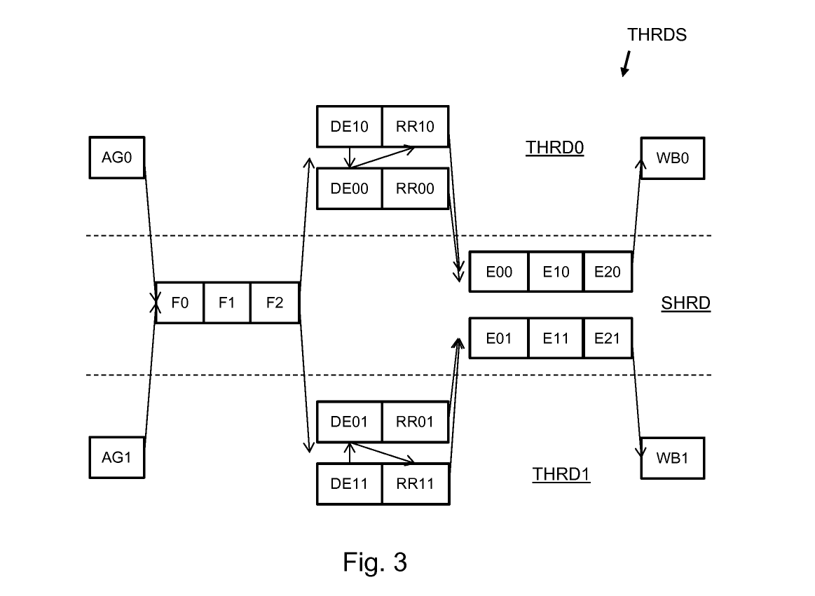

FIG. 2 schematically shows an embodiment of an electronic control unit ECU comprising a microcontroller CPU0, such as the one shown in FIG. 1.

As shown in FIG. 2, the microprocessor CPU0 may have a plurality of two or more pipelines PIP0, PIP1, PIP2, each capable of running a respective thread in parallel to running another thread on another pipeline. The pipelines may be provided by statically pre-configured functional hardware units as hardware pipelines or by a dynamically configurable configuration of a plurality of functional hardware units to form so-called software pipelines. A first pipeline PIP0 of the plurality of pipelines may execute a first thread “Thread0” and is always operational when instructions and, if applicable, associated data is available to the microprocessor CPU0. A second pipeline PIP1 of the plurality of pipelines may execute a second thread “Thread1” in different modes. According to an exemplary embodiment, the different modes comprise at least a multithread mode and a lock-step mode. Herein, the second thread “Thread1” may be operated independently from the first thread “Thread0”, or may be operated to execute substantially the same instructions as the first thread “Thread0” but on different data, in the multithread mode of operation, for example when a high-performance function is to be executed, such as when the instruction executed is an instruction associated with a high data throughput or a high computational load. Further, the second thread “Thread1” may be operated as a duplicate of the first thread “Thread0”, i.e., executing the same instructions on the same data, in the lock-step mode of operation, for example when a high-safety function is to be executed, such as when the instruction executed is an instruction associated with a ASIL-C or ASIL-D level function. Further, the second thread may be idle in a single-thread mode, for example during standby when the vehicle is parked and the microprocessor CPU0 substantially only needs to control the vehicle's alarm system and the vehicle's access system for detecting a remote control operation of opening the vehicle doors. Thus, in an embodiment, a first thread is always operational on the first pipeline PIP0; herein, the first pipeline PIP0 may be arranged to fetch instructions via a memory management unit (MMU) from a system memory MEMO and act as a master for the other pipelines PIP1, PIP2. In another embodiment, a controller CON0 may be arranged to fetch instructions via a memory management unit (MMU) from a system memory MEMO and act as a master for all pipelines PIP0, PIP1, PIP2 to, e.g., distribute over or allocate the instructions to the respective pipelines and control the operation of the different pipelines and the execution of the threads.

To provide these different modes, the electronic control unit ECU shown in FIG. 2 may comprise a system memory MEMO and a microcontroller CPU0, connected by a system bus AHB0. The system bus may also be referred to as Advanced high Speed Bus (AHB) AHB0. The system memory MEMO may comprise an array of randomly accessible memory elements RAM0 and a memory protection unit (MPU) MPU0. The MPU MPU0 is capable of partitioning the memory map of the microcontroller into defined regions and setting individual protection attributes for each region. The MPU0 may reside within or close to system interconnects, such as a crossbar or switch fabric between the randomly accessible memory elements RAM0 of the system memory MEMO and the microcontroller CPU0. For example, as shown in FIG. 2, the MPU0 may reside in the system memory MEMO between the randomly accessible memory elements RAM0 and the system bus AHB0, and may thus be positioned in between the randomly accessible memory elements RAM0 and the microcontroller CPU0. The microcontroller CPU0 comprises a Memory Management Unit (MMU) MMU0, a controller CON0 and the plurality of pipelines PIP0, PIP1, PIP2. The MMU MMU0 is similar to the MPU in terms of its capability to apply protection attributes to memory map address regions but differs in that the MMU is resident within the core of the microcontroller CPU that is used to provide access restriction and the MMY may also perform address translation for translating a virtual address to a physical address. The MMU MMU0 may comprise a Translation Lookaside Buffer (TLB) TLB0. The TLB TLB0 is arranged to acts as a cache of available settings, stored as TLB entries, to be used by the MMU MMU0. For example, software may write an address range and relevant access attributes to a TLB entry. Upon the CPU CPU0 performing a data fetch via the MMU MMU0, the TLB TBL0 may be searched for any matching entry that defines the attribute to be applied to that access.

Hereto, the microcontroller CPU0 provides a multi-thread capable processor system comprising a plurality of processor pipelines PIP0, PIP1, PIP2, wherein the multi-thread capable processor system is arranged to fetch an instruction comprising an address and to select an operation mode based on the address of the fetched instruction, the operation mode being selected from at least a lock-step mode and a multi-thread mode. If the operation mode is selected to be the lock-step mode, the multi-thread capable processor system is arranged to let at least two processor pipelines of the multi-thread capable processor system execute the instruction in lock-step mode to obtain respective lock-step results, to compare the respective lock-step results against a comparison criterion for determining whether the respective lock-step results match, and, if the respective lock-step results match: determine a matching result from the respective lock-step results, and writing back the matching results.

The pipelines PIP0,1 PIP1, PIP2 may be arranged to provide a context saving function for saving a pipeline's context in case the respective pipeline is halted when switching to a different mode, such as when execution of a thread in multithread mode is halted to free the pipeline's resources to operate in lock-step mode with another pipeline. As shown in FIG. 2, the pipelines PIP0, PIP1, PIP2 may hereto comprise context saving circuitry CSAV0, CSAV1, CSAV2. Alternatively, a context saving function may be performed by any suitable software mechanism as known in the art of context saving.

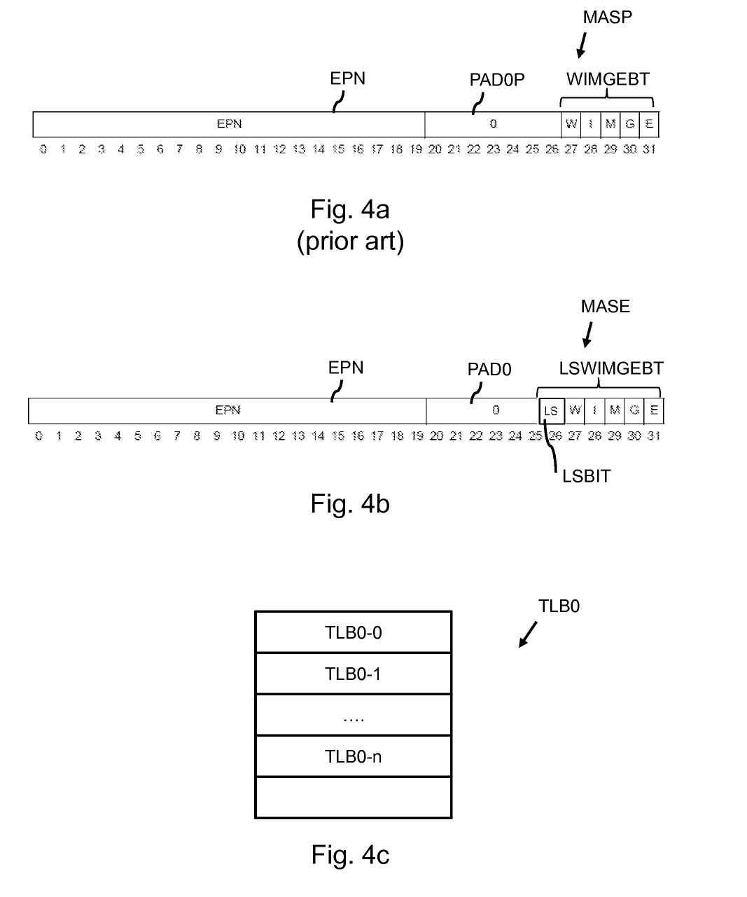

FIG. 3 schematically shows a method of operation of a plurality of two pipelines PIP0, PIP1 with respective threads THRD0, THRD0. In this example, the two pipelines PIP0, PIP1 may be operated in a lock-step mode, in single-thread mode, in multithread mode and allow associated transitions between the different modes. The two pipelines may be implemented as two parallel pipelines, with the second pipeline PIP1 being substantially a duplicate of the first pipeline PIP0, or may, as schematically shown in FIG. 3, partially share resources to, for example, execute instruction fetch stages F0, F1, F2.

FIG. 3 shows an example wherein the first thread THRD0 and the second thread THRD1 each comprise a plurality of respective thread operation stages. In a simultaneous first thread operation stage AG0, AG1, the first and second thread THRD0, THRD1 perform a respective address generation. In a plurality of next thread operation stages F0, F1, F2, the two threads use shared resources to fetch instructions. The thread operation stages F0, F1, F2 may be referred to as instruction fetch stages. The instruction fetch stages are common to both threads, in the area labeled as SHRD. Instructions propagating through the instruction fetch stages may be issued to whichever thread is active. In next thread operation stages DE10, DE00 of the first thread THRD0 and DE11, DE01 of the second thread THRD1, the instructions are decoded while reading registers in thread operation stages RR10, RR00 of the first thread THRD0 and RR11, RR01 of the second thread THRD1 in independent pipeline resources of the two threads. The thread operation stages DE10, DE00 and DE11, DE01 may be referred to as decode stages. The thread operation stages RR10, RR00 and RR11, RR01 may be referred to as register read stages. The decode stages and register read stages may operate in a plurality of different modes, such as in a multithread mode or in a lock-step mode. In further embodiments, the decode stages and register read stages may further operate in a single-thread mode. In further thread operation stages E00, E10, E20 of the first thread THRD0 and E01, E11, E21 of the second thread THRD1, both threads execute the decoded instructions on the values read from the registers in respective pipeline resources of the pipelines PIP0, PIP1 running the respective threads THRD0, THRD1. When the execution of the last stages E20, E21 is finished, the results from the first and second thread THRD0, THRD1 are written back in a register or into the memory MEMO in write back stages WB0, WB1 of the respective threads THRD0, THRD1. Where the pipelines operate in a lock-step mode, the write back stages WB0, WB1 may be preceded by, or comprise, a comparison stage, for comparing the results of both threads THRD0, THRD1 before writing back the result if the results of both threads match, or for signalling an error condition if the results of both threads are do not match.

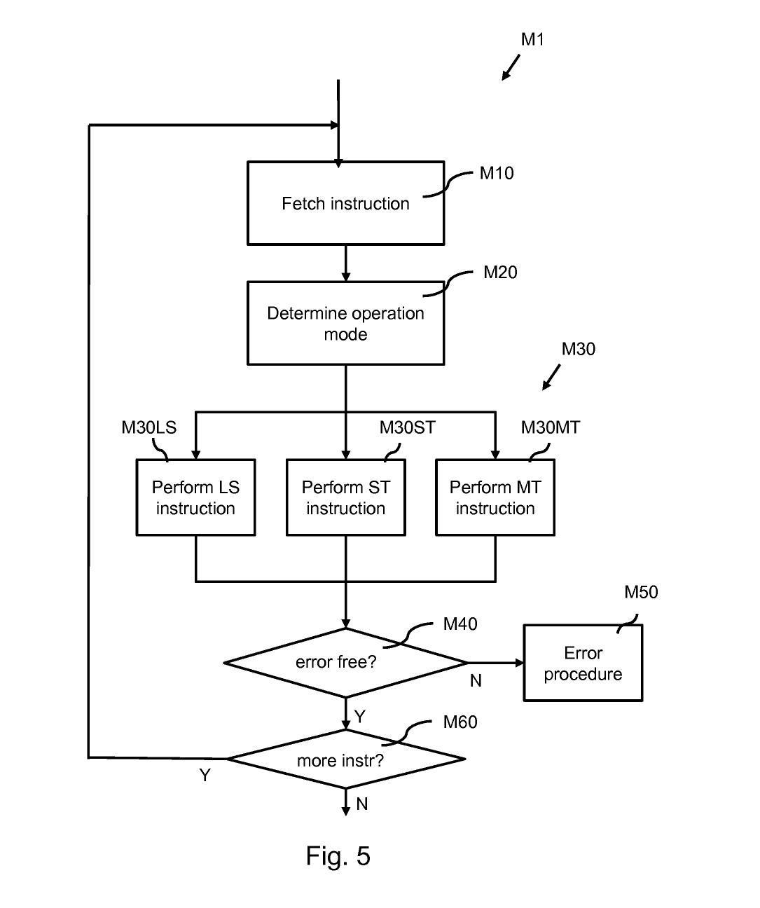

FIG. 4a and FIG. 4b schematically illustrate a prior art and an embodiment of a MMU Assist (MAS) register usable for controlling loading data from the memory into a cache. The MAS register may comprise an address range and relevant access attributes. The cache may be an attribute table comprising table entries. The attribute table may thus provide a cache of available settings to be used by a Memory Management Unit. The attribute table may, e.g., be a so-called Translation Lookaside Buffer (TLB) comprising TLB entries. In the following, any reference to a TLB may be read as a reference to any type of suitable attribute table, and any reference to a TLB entry may be read as a reference to a table entry of the attribute table. For example, software may write possible MAS register values comprising respective address ranges and relevant access attributes to respective TLB entries, and, upon the CPU performing an instruction of data fetch via the MMU, the TLB is searched for any matching entry that defines the access attribute to be applied to that access. A matching entry is a TLB entry corresponding to the MAS register having an address range comprising the address associated with the instruction. The MAS register may thus be used to load contents into the MMU's TLB, and, after the MAS is loaded with a parameter, an instruction may be executed that causes this contents to be loaded into the TLB.

FIG. 4a shows a prior art example of a MAS register MASP as used with an exemplary known microprocessor. The MAS register shown is used with the so-called e200z6 PowerPC™ core commercially sold by Freescale Semiconductor Inc, of which a Reference Manual can be found on http://cache.freescale.com/files/32 bit/doc/ref manual/E200Z6 RM.pdf, which is incorporated by reference herein. The MAS register comprises control bits, also referred to as WIMGE bits, are documented in detail in section 6.2.5 of reference document “Book E: Enhanced PowerPC™ Architecture”, version 1.0 (May 7, 2002), which is incorporated by reference herein, and which is available from http://www.freescale.com/files/32 bit/doc/user quide/BOOK EUM.pdf.

FIG. 4a shows a MAS register MASP comprising 20 so-called Effective Page Number (EPN) bits at bit positions 0-19, 7 padding bits PAD0P at bit positions 20-26, and 5 WIMGE-bits WIMGEBT at bit positions 27-31.

The EPN bits are used to define the address range upon which a TLB entry matches an access made by the CPU. It may compared with the ‘effective address’ of the access by the CPU.

The WIMGE bits WIMGEBT comprise a Write-through mode control bit W, a Cache Inhibit control bit I, a Memory Coherence required bit M, a Guarded Access control bit G and an Endianness bit E.

The Write-through mode control bit W is ‘1’ to set a mode of operation of the cache where all cache updates are written directly through to the backing store (system RAM). This may provide an improved data coherency in the system, at a small performance compromise. The Guarded Access control bit G may be used to provide a mechanism to ensure correctness of a data access in terms of data accessing instruction sequence. The Endianness bit E indicates the Endianness of the whole register MASP, indicating big or little, and defining the ordering of the byes in each word, specifically whether the most significant or least significant byte is ordered first or last. For a more extensive description of the WIMGE bits, reference is made to section 6.2.5 of the document “Book E: Enhanced PowerPC™ Architecture.

FIG. 4b shows a MAS register MASE according to an embodiment. The MAS register MASE comprises the 20 so-called Effective Page Number (EPN) bits at bit positions 0-19 and the 5 WIMGE-bits WIMGEBT at bit positions 27-31 that were described above for the prior art MAS register MASP. The MASE register further comprises 6 padding bits PAD0 at bit positions 20-25 and a, new, lock-step control bit LS at bit position 26. The lock-step control bit LS indicate whether a lock-step mode is to be used when accessing a certain address (to fetch a data or an instruction) on a per address range basis. The lock-step control bit LS and the 5 WIMGE-bits WIMGEBT may together be referred to as access attributes LSWIMGEBT of the MAS register MASE. The skilled person will appreciate that the same principle may be applied to CMPU or other core or system based memory protection or translation hardware.

FIG. 4c schematically illustrates an attribute table TLB0 according to an embodiment. The attribute table TLB0 is shown as a so-called Translation Lookaside Buffer (TLB) comprising a plurality of n TLB entries TLB0-0, TLB0-1, TLB0-n, but may be any type of suitable attribute table comprising table entries. The TLB entries comprise value of MAS registers MASE defined as shown in and discussed with reference to FIG. 4b. In particular, each TLB entry TLB0-0, TLB0-1, . . . , TLB0-n comprises respective EPB-bits defining a respective address range and access attributes, including the lock-step control bit LS.

According to an embodiment, upon the CPU CPU0 performing an instruction of data fetch from an addresses in the memory MEMO via the MMU MMU0, the attribute table TLB0 is searched for a table entry with an address range matching the address in the memory MEMO to the access attribute defines by the matching table entry. The matching table entry then provides the access attribute from which the operation mode may be determined, e.g, to be a lockstep mode, to be a multithread mode, or to be a change of operation mode.

Hereby, an address range based mechanism may be provided for signaling to the CPU to transition to a lock-step mode, and, e.g., to transition between MT mode and LS mode. Specifically, the CPU's MMU (or CMPU or equivalent) may contain programmable parameters to indicate that for a given TLB entry (or region descriptor or equivalent) the CPU should operate in either MT or LS mode.

The attribute table comprising table entries defining access attributes for respective address ranges may thus be used for selecting the operation mode based on the address of the fetched instruction.

In embodiments, selecting the operation mode based on the address of the fetched instruction comprises obtaining one or more selected access attributes from selecting the access attribute associated with the address of the fetched instruction from an attribute table TLB0 comprising a plurality of table entries TLB0-0, . . . , TLB0-n, each table entry defining at least one access attribute LSWIMGEBT for a respective address range, the access attributes defining at least one or more operation modes for operating instructions associated with addresses in the respective address range, and selecting the operating mode in dependence on the one or more selected access attributes.

In embodiments, the at least one access attributes comprising at least one operation mode control bit, and the selecting of the operation mode based on the instruction comprising determining a value of the at least one operation mode control bit.

In a further embodiment, the at least one operation mode control bit comprises at least one lock-step bit LSBIT indicating whether the instruction requires a lock-step execution, as indicated in FIG. 4b. For example, instructions associated with high ASIL safety requirements may be indicated as requiring lock-step execution with the lock-step bit LSBIT indicating so for the associated address range.

In further or alternative embodiments, the at least one operation mode control bit may comprise at least one multi-thread bit indicating whether the instruction requires a multi-thread execution. For example, instructions associated with high performance requirements such as a download of update information may be indicated as requiring multithread execution with the multithread bit indicating so for the associated address range. A plurality of multi-thread bits may be used for indicating, for example, how many threads are required in multi-thread execution.

In further or alternative embodiments, the at least one operation mode control bit comprises at least one LS/MT-bit indicating whether the instruction requires either a lock-step execution or a multi-thread execution. For example, the lock-step bit LSBIT may be defined to serve as a single LS/MT bit to indicate whether the instruction requires either a lock-step execution when the LS/MT bit set is to ‘1’, or a multi-thread execution when the LS/MT bit is set to ‘0’.

In further or alternative embodiments, the at least one operation mode control bit comprises at least one single-thread bit indicating whether the instruction allows a single-thread execution. For example, instructions associated with a low-power mode of operation, such as a control of stand-by functions, may be indicated as single-thread to achieve a low-power operation using a single pipeline.

In further or alternative embodiments, the at least one operation mode control bit may comprise at least one at least one mode-change bit indicating whether the instruction requires a change of operation mode. Such at least one mode-change bit may be combined with, for example, at least one lock-step bit, at least one multi-thread bit, at least one LS/MT-bit or at least one single-thread bit to indicate the operation mode after the change of operation mode. As further examples, such at least one mode-change bit may be combined with at least one lock-step bit and at least one multi-thread bit, or such at least one mode-change bit may be combined with at least one lock-step bit at least one LS/MT-bit to indicate the operation modes before and after the change of operation mode.

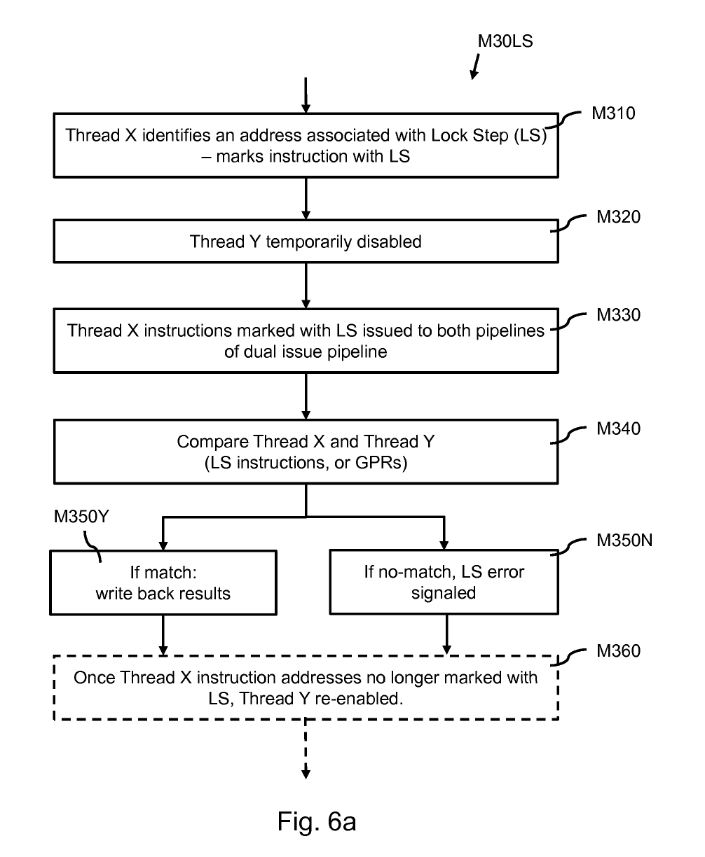

FIG. 5 schematically shows a method of operating a multi-thread capable processor system CPU0 comprising a plurality of processor pipelines PIP0, PIP1. As shown in FIG. 5, the method comprises fetching M10 an instruction comprising an address. Next, the method comprises selecting M20 an operation mode based on the address of the fetched instruction. Herein, the operation mode may be selected from at least a lock-step mode and a multi-thread mode. The operation mode may further be selected to be a single-thread mode. The method further comprises operating M30 the multi-thread capable processor system in the selected mode. Depending on the selected operation mode, the method may hereto perform a lock-step operation M30LS, a single-thread operation M30ST or a multithread operation M30MT.

After, or in alternative embodiment during, the operation in the selected operation mode, the method may comprise checking M40 whether the operation resulted in any errors. If the operation resulted in one or more errors, the method may execute M50 an error procedure. The CPU CPU0 may for example be able to detect and handle a range of exceptions associated with different faults. For example, the CPU may be arranged to handle exceptions associated with data transfer errors, instruction fetch errors, external interrupt errors, or, after a multithread operation, an error associated with different results from the different threads of the multithread operation. If the operation is error free, or if no errors have been detected, the method continues with checking M60 whether there are more instructions. If so, the method proceeds again with fetching instructions M10.

The at least two processor pipelines of the multi-thread capable processor system may be arranged to execute a sequence of instructions using at least a first thread in any operation mode, and the at least two processor pipelines of the multi-thread capable processor system may further be arranged to execute instructions in lock-step mode and/or in multi-thread mode using the first thread and at least a second thread. For example, fetching M10 the instructions may be performed by one of the processor pipelines which is arranged to execute the first thread in any operation mode. This first thread may be referred to as a master thread and the processor pipeline executing the master thread may be referred to as a master processor pipeline. Thus, the at least two processor pipelines may comprise a master processor pipeline, and the master processor pipeline may be arranged to execute the first thread. In further embodiments, the master processor pipeline may be further arranged to fetch the instruction, to select the operation mode based on the instruction, and to let the respective one or more processor pipelines of the multi-thread capable processor system execute the instruction.

Thus, the method may allow identifying an instruction, or a sequence of instructions forming a code section, to be run in one of different modes. Hereby, ASIL-x compliant applications and non-ASIL-x compliant application may, for example, be more easily combined on the same multi-thread capable processor. The method may provide a mechanism to operate in lock-step mode for applications with high functional safety requirements and in a multithread mode as a high performance mode for less-safety-critical portions of the application, based upon the address range of the fetched instructions.

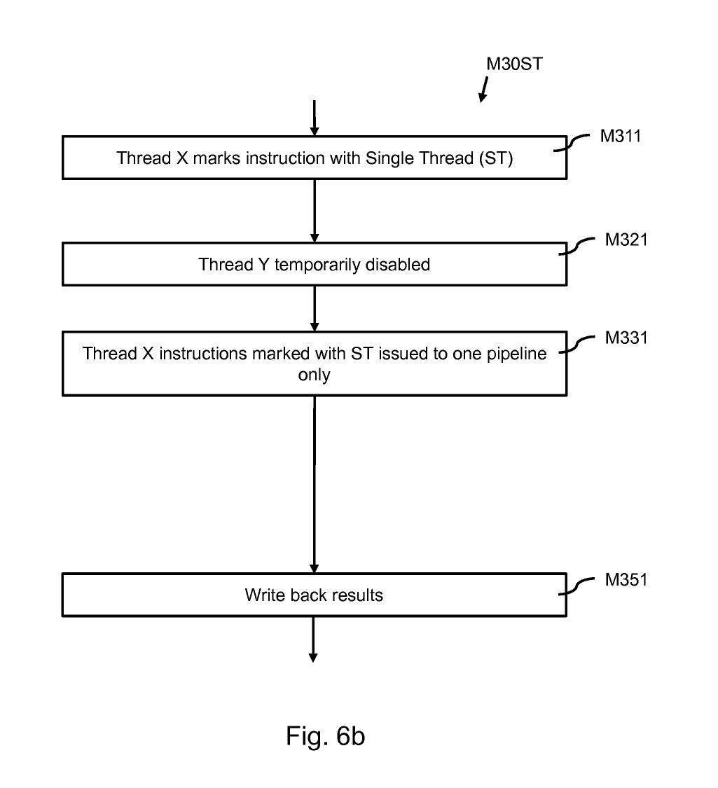

FIG. 6a schematically shows operating M30LS the multi-thread capable processor system in a lock-step mode according to an embodiment. The operation is described starting from a situation wherein a first thread and a second thread are being executed on the at least two processor pipelines of the multi-thread capable processor system when an instruction is fetched. The skilled person will, based on the description given below, appreciate how the method operates when only one thread, i.e. the first thread, is active. The first thread will herein further be referred to as ThreadX, and the second thread will further be referred to as ThreadY. The threads ThreadX and ThreadY may correspond to THRD0 and THRD1 of FIG. 2, or may be different threads. The first thread may be a master thread as described above.

According to the exemplary embodiment, the first thread identifies M310 the instruction as having an address marked as lockstep with the LSbit in the MAS register MASE retrieved from the attribute table TLB in dependence on the address in the instruction. Herefrom, the operation mode is selected to be the lock-step mode, and selection of the operation mode results in a change of the operation mode from the multithread mode to the lock-step mode.

Then, the method comprises halting M320 at least one processor pipeline of the multi-thread capable processor system for making the at least one processor pipeline available for executing the instruction in the lock-step mode. Hereto, the second thread ThreadY is temporarily halted. Upon halting the at least one processor pipeline, the method may comprise saving a context of the at least one pipelines that are halted, to allow continuing the execution of the second thread after the lock-step operation is completed. The method further comprises letting the at least one processor pipeline that is halted execute the instruction in lock-step mode together with one or more other pipelines to obtain the respective lock-step results. Hereto, the instructions issued to the master pipeline are issued M330 to both processor pipelines for letting the two processor pipelines PIP0, PIP1 of the multi-thread capable processor system CPU0 execute the instruction in lock-step mode to obtain respective lock-step results. The method further comprises comparing M340 the respective lock-step results against a comparison criterion for determining whether the respective lock-step results match. For example, the comparison criterion may correspond to numerical results from both processor pipelines PIP0 PIP1 being exactly equal, or differing by at most a predetermined deviation. The comparison may be performed by dedicated hardware comparators and Logic arranged to ensure contents of both threads is identical. If the respective lock-step results match, the method comprises determining a matching result from the respective lock-step results, and writing back M350Y the matching result. The CPU may e.g. comprise General Purpose Registers (GPRs) for storing data that is operated upon as well as intermediate values of operations, and the matching result may be written back in one or more these GPUs. If the respective results do not match, the method comprises signalling M350N an error. Signalling the error may for example trigger a CPU exception handling routine or circuit, causing the CPU to jump to a defined interrupt service routine.

Once instructions issued to the master pipeline are no longer associated with address for which the operation mode is indicated to be lock-step, the second thread ThreadY is re-enabled M360 to complete its execution in multithread mode.

In alternative or further embodiments, the method further comprises, where the selection of the operation mode results in a change of the operation mode from the multithread mode to the lock-step mode, halting at least one processor pipeline of the multi-thread capable processor system for making the at least one processor pipeline available for executing the instruction in the lock-step mode, and before halting the at least one processor pipeline, letting the at least one processor pipeline complete instructions that are in progress.

In alternative or further embodiments, the method may further comprise, if the operation mode is selected to be the multi-thread mode, letting a first processor pipeline PIP0 of the at least two processor pipelines of the multi-thread capable processor system execute the instruction in a first thread of the multithread mode to obtain a first multi-thread result, and, if a different, second processor pipeline PIP1 of the at least two processor pipelines is executing a second thread, letting the second processor pipeline continue to execute the second thread to obtain a second multi-thread result. Thus, where the second processor pipeline is already executing the second thread, the method lets the first processor pipeline of the at least two processor pipelines of the multi-thread capable processor system execute the instruction in the first thread of the multithread mode while letting the second processor pipeline continue to fetch and execute instructions substantially independently in the second thread of the multithread mode.

The lock-step mode may be associated with using one or more registers and/or one or more execution units of the at least two processor pipelines of the multi-thread capable processor system to execute the instruction at least in duplicate by the at least two processor pipelines.

FIG. 6b schematically shows operating M30ST the multi-thread capable processor system in a single-thread mode according to an embodiment. Again, the operation is described starting from a situation wherein a first thread and a second thread are being executed on the at least two processor pipelines of the multi-thread capable processor system when an instruction is fetched. The skilled person will, based on the description given below, appreciate how the method operates when only one thread, i.e. the first thread, is active. The first thread will herein further be referred to as ThreadX, and the second thread will further be referred to as ThreadY. The threads ThreadX and ThreadY may correspond to THRD0 and THRD1 of FIG. 2, or may be different threads. The first thread may be a master thread as described above.

According to the exemplary embodiment, the first thread identifies M311 the instruction to be associated with a single-thread operation. The method then further comprises temporarily disabling M321 the second thread ThreadY. The method further comprises letting M331 one processor pipeline (PIP0) of the multi-thread capable processor system execute the instruction in a single-thread mode to obtain a single-thread result from issuing the instructions to a single pipeline only. The method further comprises writing back M351 the single-thread result.

FIG. 6c schematically shows operating M30MT the multi-thread capable processor system in a multithread mode according to an embodiment. The operation is described starting from a situation wherein at least first thread is being executed on a first processor pipeline of the at least two processor pipelines of the multi-thread capable processor system when an instruction is fetched. The skilled person will, based on the description given below, appreciate how the method operates when only two or more threads are active. The first thread will herein further be referred to as ThreadX, and the second thread will further be referred to as ThreadY. The threads ThreadX and ThreadY may correspond to THRD0 and THRD1 of FIG. 2, or may be different threads. The first thread may be a master thread as described above.

According to the exemplary embodiment, the first thread identifies M312 the instruction as having an address indicated as multithread by attribute bits in the MAS register MASE retrieved from the attribute table TLB in dependence on the address in the instruction. Herefrom, the operation mode is selected to be the multithread mode, and selection of the operation mode results in a change of the operation mode to the multithread mode. The instruction may be marked with MT, to indicate it is to be executed in multithread mode. The method further comprises letting the first processor pipeline execute instructions in multithread mode to obtain a first multithread result. Hereto, the instructions marked with MT are issued M322 to the first pipeline PIP0. The method further comprises letting the second processor pipeline execute instructions in multithread mode to obtain a second multithread result. Hereto, the instructions marked with MT are issued M332 to the second pipeline PIP1. The results of both threads may be gathered M342 to obtain gathered results. Lastly, the method comprises writing back the first and second multithread results, or, if the results have been gathered, writing back the gathered results.

The multithread mode may be associated with using one or more registers and/or one or more execution units of the at least two processor pipelines of the multi-thread capable processor system to execute the instruction.

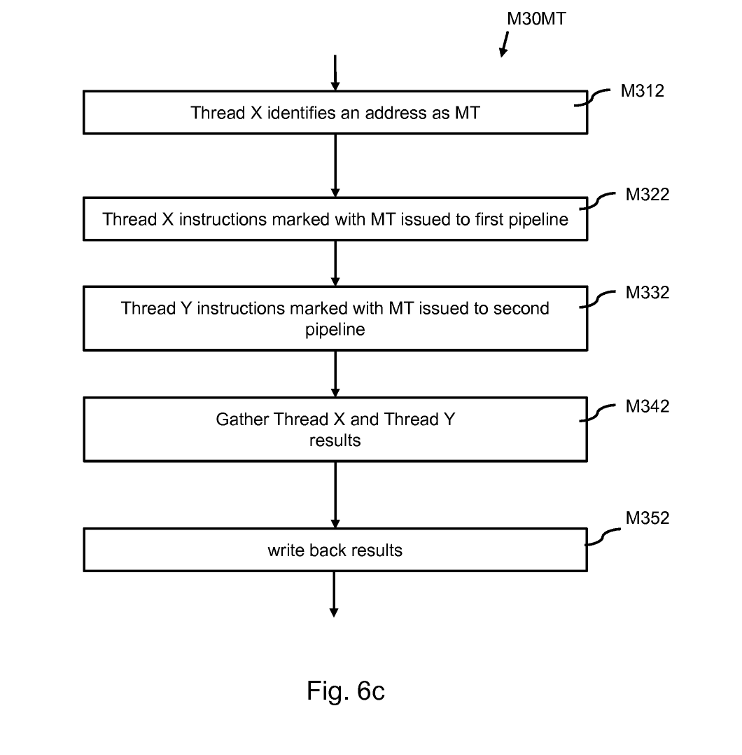

FIG. 7 schematically shows an exemplary user interaction system 2000 having a programmable processor 2005. The user interaction system 2000 is shown to be a personal computer, but may be any type of suitable user interaction system 2000. The programmable processor 2005 is arranged to be able to communicate with a programmable target 1 as indicated. The programmable target 1 may for example be a ECU according to an embodiment as described with reference to FIG. 1, a CPU CPU0 according to an embodiment as described with reference to FIG. 2, or another programmable device or programmable system capable comprising a plurality of processor pipelines. The user interaction system 2000 further comprises a storage unit 2007, a user input 2003 and a display 2006. The user input 2003 allows the user to input user data and user instructions 2004 to the processor 2005 by e.g. using a keyboard 2001 or a mouse 2002. Also, although not shown, the display 2006 may comprise a touch-sensitive surface for enabling the user to provide user data and user instructions to the user input 2003 by means of touching the display 2006. The processor 2005 is arranged to perform any one of the methods according to the invention, to receive user data and user instructions 2004, to present visual information on the display 2006 and to communicate with a data I/O device 2009, such as an optical disc drive or a solid state reader/writer. The processor 2005 is arranged to cooperate with the storage unit 2007, allowing storing and retrieving information on the storage unit 2007. The user interaction system 2000 may further comprise a communication channel 2008 allowing the processor 2005 to connect to an external cloud 2500 for communicating with other devices in the cloud. The external cloud may e.g. be the Internet. The processor 2005 may also be arranged to retrieve information from the storage unit 2007, or from another device in the cloud 2500, and generate the memory trace from combining the record of static memory address information and the record of dynamic memory address information offline by the processor 2005. The processor 2005 may be capable to read, using the data I/O device 2009, a computer readable medium comprising a program code 1 executable on a programmable target 2. The processor 2005 may be capable to read, using the data I/O device 2007, a computer readable medium comprising a computer program product comprising instructions for causing the system 1000 to perform a method of generating an instrumented code 13 from a program code 1 executable on the programmable target 2. The processor 2005 may be capable to read, using the data I/O device 2007, a computer readable medium comprising a computer program product comprising instructions for causing the system 1000 to perform a method of operating a multi-thread capable processor system comprising a plurality of processor pipelines according to any one embodiment described above.

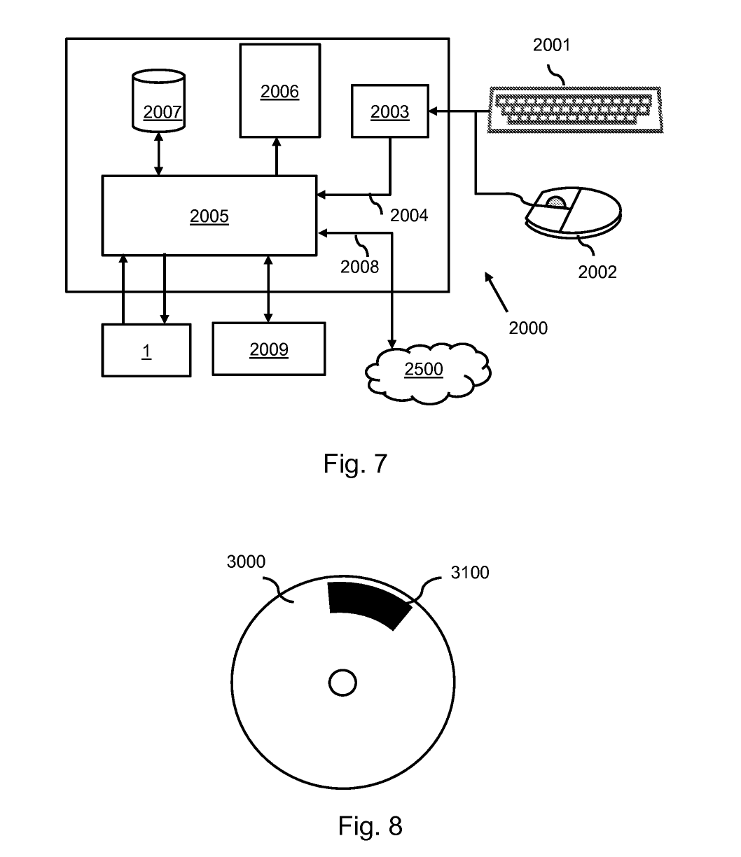

FIG. 8 shows a computer readable medium 3000 comprising a computer program product 3100, the computer program product 3100 comprising instructions for causing a processor system to perform a method of operating a multi-thread capable processor system comprising a plurality of processor pipelines according to any one embodiment described above. The computer program product 3100 may be embodied on the computer readable medium 3000 as physical marks or by means of magnetization of the computer readable medium 3000. However, any other suitable embodiment is conceivable as well. Furthermore, it will be appreciated that, although the computer readable medium 3000 is shown in FIG. 8 as an optical disc, the computer readable medium 3000 may be any suitable computer readable medium, such as a hard disk, solid state memory, flash memory, etc., and may be non-recordable or recordable.

An operating system (OS) is the software that manages the sharing of the resources of a computer and provides programmers with an interface used to access those resources. An operating system processes system data and user input, and responds by allocating and managing tasks and internal system resources as a service to users and programs of the system.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-ROM or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

As used herein, the term “bus” is used to refer to a plurality of signals or conductors which may be used to transfer one. The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of system ECU are circuitry located on a single integrated circuit or within a same device. Alternatively, system ECU may include any number of separate integrated circuits or separate devices interconnected with each other. For example, memory MEMO may be located on a same integrated circuit as CPU CPU0 or on a separate integrated circuit or located within another peripheral or slave discretely separate from other elements of system ECU. Also for example, system ECU or portions thereof may be soft or code representations of physical circuitry or of logical representations convertible into physical circuitry. As such, system ECU may be embodied in a hardware description language of any appropriate type.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of system ECU, for example, from computer readable media such as memory 3000 or other media on other computer systems. Such computer readable media may be permanently, removably or remotely coupled to an information processing system such as system 2000. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In one embodiment, system 2000 is a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device. Also, devices functionally forming separate devices may be integrated in a single physical device. Also, the units and circuits may be suitably combined in one or more semiconductor devices.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of operating a multi-thread capable processor system comprising a plurality of processor pipelines, the method comprising:
fetching an instruction comprising an address;
selecting an operation mode based on the address of the fetched instruction, wherein the operation mode is selected from at least a lock-step mode and a multi-thread mode; and
if the operation mode is selected to be the lock-step mode:
letting at least two processor pipelines of the multi-thread capable processor system execute the instruction in lock-step mode to obtain respective lock-step results,
comparing the respective lock-step results against a comparison criterion for determining whether the respective lock-step results match, and,
determining a matching result from the respective lock-step results and writing back the matching results, if the respective lock step results match.

2. A method according to claim 1, further comprising:
signalling an error if the respective lock step results do not match.

3. A method according to claim 1, further comprising:
if the operation mode is selected to be the multi-thread mode:
letting a first processor pipeline of the at least two processor pipelines of the multi-thread capable processor system execute the instruction in a first thread of the multithread mode to obtain a first multi-thread result, and
if a different, second processor pipeline of the at least two processor pipelines is executing a second thread, letting the second processor pipeline continue to execute the second thread to obtain a second multi-thread result.

4. A method according to claim 1, further comprising: selecting the operation mode from at least a lock step mode, a multi-thread mode, and a single-thread mode; and
if the operation mode is the single-thread mode:
letting one processor pipeline of the multi-thread capable processor system execute the instruction in a single-thread mode to obtain a single-thread result, and
writing back the single-thread result.

5. A method according to claim 1, wherein selecting the operation mode based on the address of the fetched instruction comprises:
obtaining one or more selected access attributes from selecting the access attribute associated with the address of the fetched instruction from an attribute table comprising a plurality of table entries, wherein each table entry defines at least one access attribute for a respective address range, and
the access attributes define at least one or more operation modes for operating instructions associated with addresses in the respective address range; and
selecting the operating mode in dependence on the one or more selected access attributes.

6. A method according to claim 5, wherein the at least one access attributes comprises at least one operation mode control bit, and
the selecting of the operation mode based on the instruction comprises determining a value of the at least one operation mode control bit.

7. A method according to claim 6, wherein the at least one operation mode control bit comprises at least one lock-step bit indicating whether the instruction requires a lock-step execution.

8. A method according to claim 6, wherein the at least one operation mode control bit comprises at least one multi-thread bit indicating whether the instruction requires a multi-thread execution.

9. A method according to claim 6, wherein the at least one operation mode control bit comprises at least one LS/MT-bit indicating whether the instruction requires either a lock-step execution or a multi-thread execution.

10. A method according to claim 6, wherein the at least one operation mode control bit comprises at least one single-thread bit indicating whether the instruction allows a single-thread execution.

11. A method according to claim 5, wherein the at least one operation mode control bit comprises at least one at least one mode-change bit indicating whether the instruction requires a change of operation mode.

12. A method according to claim 1, wherein the at least two processor pipelines of the multi-thread capable processor system are arranged to execute a sequence of instructions using at least a first thread in any operation mode, and to execute instructions in one or more of a lock-step mode or in multi-thread mode using the first thread and at least a second thread.

13. A method according to claim 12, wherein the at least two processor pipelines comprise a master processor pipeline, the master processor pipeline being arranged to execute the first thread.

14. A method according to claim 1, where the selection of the operation mode results in a change of the operation mode from the multithread mode to the lock-step mode, the method further comprising:
halting at least one processor pipeline of the multi-thread capable processor system for making the at least one processor pipeline available for executing the instruction in the lock-step mode;
saving a context of the at least one pipelines that are halted; and
letting the at least one processor pipeline that is halted execute the instruction in lock-step mode together with one or more other pipelines to obtain the respective lock-step results.

15. A method according to claim 1, where the selection of the operation mode results in a change of the operation mode from the multithread mode to the lock-step mode, the method further comprising:
halting at least one processor pipeline of the multi-thread capable processor system for making the at least one processor pipeline available for executing the instruction in the lock-step mode, and
before halting the at least one processor pipeline, letting the at least one processor pipeline complete instructions that are in progress.

16-20. (canceled)
